(19) United States
(12) Patent Application Publication
(10) Pub. No.: US 2024/0338629 A1
(43) Pub. Date: Oct. 10, 2024

(54) PREDICTING SAFETY INCIDENTS BASED UPON OBSERVATION AND PROJECT DATA

(71) Applicant: Insight Direct USA, Inc., Chandler, AZ (US)

(72) Inventor: Dimitri Ofiesh, Falls Church, VA (US)

(21) Appl. No.: 18/626,525

(22) Filed: Apr. 4, 2024

Related U.S. Application Data
(60) Provisional application No. 63/457,655, filed on Apr. 6, 2023.

(51) Int. Cl. G06Q 10/0635; G06Q 10/0639; G06Q 50/08

(52) U.S. Cl. CPC G06Q 10/0635; G06Q 10/0639; G06Q 50/08

(57) ABSTRACT

A method of predicting the likelihood of a future unsafe incident occurring at a project can include receiving project data and observation data, extracting features from the types of data that are most indicative of the occurrence of the future unsafe incident at the project, and predicting, dependent upon the predictive features that are most indicative of the occurrence of a future unsafe incident, the likelihood of the future unsafe incident occurring at the project. Extraction of the features can include receiving another project's project data, observation data, and incident data, associating the other project's observation data with the incident data by linking a date of the observation data to a date of the unsafe incidents, identifying predictive features that include the types of project data and the types of observation data that are most indicative of an occurrence of the unsafe incident at the other project.

### CROSS-REFERENCE TO RELATED APPLICATION

The present application claims priority to U.S. provisional patent application Ser. No. 63/457,655 by D. Ofiesh, filed Apr. 6, 2023 and entitled “PREDICTING SAFETY INCIDENTS BASED UPON OBSERVATION AND PROJECT DATA.”

### FIELD OF THE INVENTION

The disclosure relates generally to safety of a project worksite, such as a construction site, and more specifically, to using project data and observation data to predict the likelihood of the occurrence of a future unsafe incident at the project worksite.

### BACKGROUND

On a project worksite, such as a construction site, safety incidents can arise due to general unsafe practices, environmental conditions, natural phenomena, or other reasons. These unsafe incidents can be of varying severity, including incidents that must be reported to the Occupational Safety and Health Administration (hereinafter, “OSHA”), incidents that results in days away, restricted, or transferred workers (hereinafter, “DART”), and incidents that result in lost time of the worker. These safety incidents can result in injuries to workers, fines, lawsuits, damage to property, missed project deadline, and other issues.

### SUMMARY

A method of predicting the likelihood of an unsafe incident occurring at a first worksite of a first project can include receiving first project data that includes at least one of the following types: a cost of the first project, a projected start date of the first project, an actual start date of the first project, a projected completion date of the first project, a size of the first worksite of the first project, a location of the first worksite, a contract type of a contract under which work at the first worksite is performed, a procurement method of the contract, a value of the contract, an insurance type of a workers' compensation policy covering work performed at the first project, a policy holder of the workers' compensation policy, and a number of change orders performed at the first worksite. The method can also include receiving first observation data that includes at least one of the following types: a date of the observation, a safety category of the observation with the safety category identifying the observation as one of a safe observation or an unsafe observation, a category of worker that was observed, a category of activity that was observed, a cause of the activity that was observed, a number of observations made on the date of the observation, a ratio of safe observations to unsafe observations, a day of week of the date of the observation, a difference in time between the date of the observation and a date of recordation of the observation, and a difference in time between the date of the observation and a date of corrective action. The method can also include receiving first incident data that includes at least one of the following types: a date of a reported unsafe incident associated with the first project, a severity of the unsafe incident, a category of worker associated with the unsafe incident, a project associated with the unsafe incident, a category of activity associated with the unsafe incident, a total number of reported unsafe incidents associated with the first project, a first variable indicating if the reported unsafe incident occurred on the project on a particular date, a second variable indicating the severity of the reported unsafe incident occurring on the project on a particular date, and a third variable indicating if no reported unsafe incident occurred on the project on a particular date. The method can also include, from features that include at least one of the types of first observation data and the types of first project data that are most indicative of the occurrence of the reported unsafe incident, predicting, by an incident predictor, the likelihood of an occurrence of a first future unsafe incident at the first project.

A system for predicting the likelihood of an unsafe incident occurring at a first worksite of a first project can include first project data that includes at least one of the following types: a cost of the first project, a projected start date of the first project, an actual start date of the first project, a projected completion date of the first project, a size of the first worksite of the first project, a location of the first worksite, a contract type of a contract under which work at the first worksite is performed, a procurement method of the contract, a value of the contract, an insurance type of a workers' compensation policy covering work performed at the first project, a policy holder of the workers' compensation policy, and a number of change orders performed at the first worksite. The system can also include first observation data that includes at least one of the following types: a date of the observation, a safety category of the observation, the safety category identifying the observation as one of a safe observation or an unsafe observation, a category of worker that was observed, a category of activity that was observed, a cause of the activity that was observed, a number of observations made on the date of the observation, a ratio of safe observations to unsafe observations, day of week of the date of the observation, a difference in time between the date of the observation and a date of recordation of the observation, and a difference in time between the date of the observation and a date of corrective action. The system can also include first incident data that includes at least one of the following types: a date of a reported unsafe incident associated with the first project, a severity of the unsafe incident, a category of worker associated with the unsafe incident, a project associated with the unsafe incident, a category of activity associated with the unsafe incident, a total number of reported unsafe incidents associated with the first project, a first variable indicating if the reported unsafe incident occurred on the project on a date, a second variable indicating the severity of the reported unsafe incident occurring on the project on a date, and a third variable indicating if no reported unsafe incident occurred on the project on a date. The system can also include an incident predictor, which includes a computer processor, configured to receive the first project data, the first observation data, and the first incident data and predict, from features that include at least one of the types of first observation data and the types of first project data that are most indicative of the occurrence of the reported unsafe incident, the likelihood of an occurrence of a first future unsafe incident at the first project.

A method of predicting the likelihood of a future unsafe incident occurring at a first worksite of a first project can include receiving first project data associated with the first project and first observation data associated with the first project, the first project data having a plurality of types of project data and the first observation data having a plurality of types of observation data, extracting, by an incident predictor that includes a machine-learning model, features from the types of project data and the types of observation data that are most indicative of the occurrence of the future unsafe incident at the first worksite of the first project, and predicting, by the machine-learning model and dependent upon predictive features that are most indicative of the occurrence of a future unsafe incident, the likelihood of the future unsafe incident occurring at a first worksite of a first project. The extraction can include receiving second project data associated with a second project, the second project data includes the plurality of types of project data having different values of project data as compared to the first project data; receiving second observation data associated with the second project, the second observation data includes the plurality of types of observation data having different values of observation data as compared to the first observation data; receiving second incident data associated with the second project, the second incident data includes incident data regarding unsafe incidents and safe incidents at the second project; associating the second observation data with the first incident data by linking a date of the observation data to a date of the unsafe incidents; and identifying the predictive features that include the plurality of types of project data and the plurality of types of observation data that are most indicative of an occurrence of the unsafe incident at the second project.

### BRIEF DESCRIPTION OF THE DRAWINGS

FIG. 1A is a schematic of an example of two projects at two different worksites having project data, observation data, and incident data for use by a system in predicting the likelihood of an unsafe incident occurring at either of the two project worksites.

FIG. 1B is a schematic of an example of an incident predictor of the system of FIG. 1A.

FIG. 2 is a flow diagram of an example process of predicting the likelihood of the occurrence of a future unsafe incident.

FIG. 3 is a flow diagram of an example process of training a machine-learning model to predict the likelihood of the occurrence of the future unsafe incident.

While the above-identified figures set forth one or more examples of the present disclosure, other examples/embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

Systems and related methods are disclosed herein for use in predicting the likelihood of an unsafe incident occurring on a project, such as a construction project or other project at which safety of workers and/or materials may be of concern. The systems and methods use project data (which can be data specific to the particular project), observation data (which can be data that is received from workers observing conduct/activity at the worksite of the project), weather data (which can be data regarding the particular weather before and during work on the project), and worker data (which can be data about the workers performing work on the project). The system can use an incident predictor, which can include and/or implement a computer processor and/or one or multiple machine-learning models, to extract the features from the project data, the observation data, the weather data, and/or the worker data that are most indicative of the occurrence of an unsafe incident and then use those features to predict the likelihood of the occurrence of a future unsafe incident. The features can include particular types of project data, particular types of observation data, particular types of weather data, and/or particular types of worker data that then can be used with regards to new project data, observation data, weather data, and/or worker data received from another project to predict the likelihood of the occurrence of a future unsafe incident at that other project.

The systems and related methods can include training the machine-learning model with test data and/or data from a first project for use in predicting the likelihood of the occurrence of a future unsafe incident at that first project or at another project that has a different worksite than the first project (i.e., physically remote from or otherwise geographically distinct from the first project and having different project data, observation data, weather data, and/or worker data). Thus, the systems and related methods can additionally receive incident data that includes data of a reported unsafe incident. To train the systems and methods, the first observation data (from the first project), the first weather data (from the first project), and/or the first worker data (from the first project) can be associated with the first incident data (from the first project) by linking the date of the reported unsafe incident with the date of the observations, the date of the weather, and/or the date of the workers data (e.g., all incident data, observation data, weather data, and worker data having the same date are associated with one another).

Additionally, the systems and methods can categorize all other observation data, weather data, and/or worker data (i.e., observation data, weather data, and/or worker data that is not linked to a reported unsafe incident) as being associated with no unsafe incidents (and thus potentially indicative of the occurrence of no unsafe incident). This provides test data having observation data, weather data, and/or worker data associated with an unsafe incident and observation data, weather data, and/or worker data that are associated no unsafe incident. The systems and methods can then determine which types of data of the observation data, which types of data of the project data (which can be data that pertains to the project overall and not a specific date), which types of data of the weather data, and/or which types of data of the worker data are most indicative of the reported unsafe incident and categories those types of data as features that are used by the machine-learning model to predict the likelihood of the occurrence of an unsafe incident.

These features (which can include types of data of observation data, types of data of project data, types of data of weather data, and/or types of data of worker data) can then be extracted from information received from the first project and used to predict the occurrence of a future unsafe incident at the first project. Additionally, these features (which can be types of data of observation data, types of data of project data, types of data of weather data, and/or types of data of worker data) can be extracted from information received from a second project (and/or other projects) and used to predict the occurrence of a future unsafe incident at the second project (and/or other projects) from which no incident data is received.

The project data (from either the first project, the second project, or both) can include the following types of data: a cost of the project, a projected start date of the project, an actual start date of the project, a projected completion data of the project, a size of a worksite (e.g., construction cite area) of the project, a location of the project worksite, a type of contract under which work/construction/operation of the worksite is performed (e.g., a fixed price contract, a cost plus fee contract, etc.), a procurement method of the contract (e.g., hard bid, lowest price technically acceptable, etc.), a value of the contract, an insurance type of a workers' compensation policy covering work performed at the first project, a policy holder of the workers' compensation policy (e.g., the construction company, the building owner, another party, etc.), a number of change orders performed on the project/at the worksite, and other information/data specific to the project.

The observation data can be collected from persons/workers of/at any of the projects, and can be collected from reports/inputs/entries provided by the persons/workers at routine intervals, such as daily observations of safe and unsafe incidents/situations. The observation data (from either the first project, the second project, or both) can include the following types of data: a date of the observation by a worker of either a safe incident/situation or an unsafe incident/situation (either reported or unreported), whether the observation was of a safe or unsafe incident/situation (either reported or unreported), a category of worker/person that was observed (e.g., welder, crane operator, etc.), the project associated with the observation, the person making the observation, a category of activity that was observed (e.g., tripping over uneven terrain, dropping tool, etc.), the date that the observation was entered/reported, textual entries made by persons/workers explaining the observation, a cause of the activity that was observed (e.g., competency, complacency, equipment failure, etc.), a number of observations made on the date of the observation; a ratio of safe observations to unsafe observations; a day of the week of the date of the observation; a difference in time between the date of the observation and a date of recordation of the observation (e.g., how long it took for the worker to submit a report of the observation after observing the activity), a difference in time between the date of the observation and a date of corrective action (e.g., how long it took for corrective action to be taken from the time of an unsafe observation), and other information/data by any persons associated with any of the projects.

The weather data can be collected from various weather reporting sources and/or can be collected from persons/workers of/at any of the projects, and can be collected from reports/inputs/entries provided by the persons/workers at routine intervals. The weather data (from either the first project, the second project, or both) can include the following types of data: current weather data (e.g., precipitation, wind, temperature, sunlight, etc.), a date of the current weather data, forecasted weather data (e.g., the prediction of the precipitation, wind, temperature, sunlight, etc. on a particular date), a date of the forecasted weather data, and other information/data regarding the weather.

The worker data can be collected from persons/workers of/at any of the projects, and can be collected from reports/inputs/entries provided by the persons/workers at routine intervals, such as daily and at the same time as the collection of the observation data. The worker data can also be provided by a foreman or other person with knowledge of the persons/workers on the worksite each day. The worker data (from either the first project, the second project, or both) can include the following types of data: a number of workers in each worker category on the project on each date (e.g., how many laborers, managers, safety personnel, etc. were on the worksite each day that work was being performed), an age of each worker on the project on each date, an amount of experience of each worker on the project on each date, a total number of workers on the project on each date, and other/information/data regarding the persons/workers at the worksites of the projects.

The incident data (from either the first project, the second project, or both) can include the following types of data: a date of a reported unsafe incident, a severity of the incident, a category of worker/person associated with the unsafe incident, a project associated with the unsafe incident (e.g., the project at which the unsafe incident occurred), a category of activity associated with the unsafe incident (e.g., what the person was doing at the time of the unsafe incident), a total number of reported unsafe incidents associated with the project, a variable indicating if the reported unsafe incident occurred on the project on a particular date, a variable indicating the severity of the reported unsafe incident occurring on the project on a particular date, a variable indicating if no reported unsafe incident occurred on the project on a particular date, and other information/data regarding a reported unsafe incident at any of the projects.

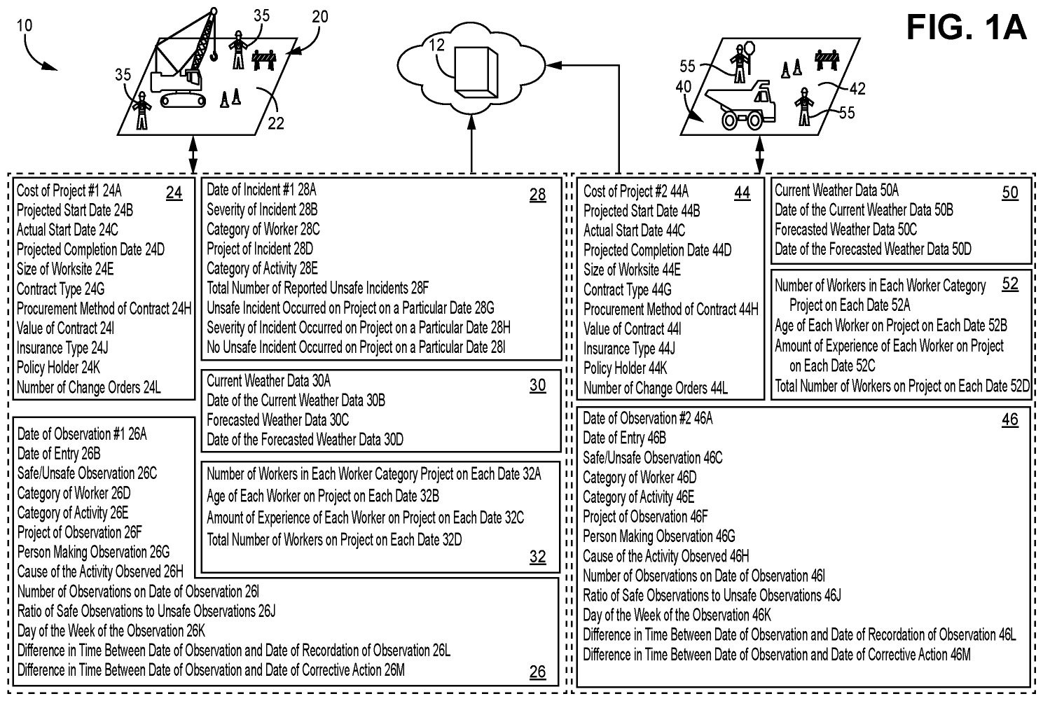

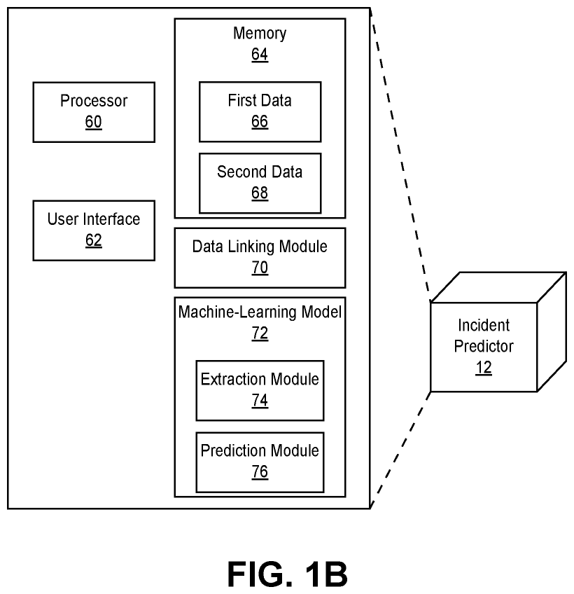

The disclosed systems and methods for predicting the likelihood of the occurrence of a future unsafe incident can help prevent the occurrence of a future unsafe incident by informing those associated with the respective project the likelihood of the occurrence of an unsafe incident so that proper safety protocols can be established and/or followed. The reduction and/or prevention of an unsafe incident can result in the saving of money, time, injuries, and other consequences. These and other advantages will be realized by reviewing the disclosure with regards to FIGS. 1A, 1B, 2, and 3.

FIG. 1A is a schematic of a system with two projects at two different worksites (e.g., worksites that are physically remote from one another) with the first project having project data, observation data, weather data, worker data, and incident data for use in training an incident predictor and for use in predicting the likelihood of the occurrence of an unsafe incident at the first project worksite and the second project having project data, observation data, weather data, and worker data for use in predicting the likelihood of the occurrence of an unsafe incident at the second project worksite. FIG. 1B is a schematic of an example of an incident predictor used by the disclosed systems and methods.

As shown in FIG. 1A, system 10 can include incident predictor 12. Incident predictor 12 can be provided information/data regarding first project 20 at first worksite 22. The information/data from first project 20 can include first project data 24, first observation data 26, first incident data 28, first weather data 30, and first worker data 32 (collectively referred to as first data 66 with reference to FIG. 1B), and the information/data from first project 20 (that includes first incident data 28) can be used as test data to train incident predictor 12. First observation data 26 can be provided by persons/workers 35 associated with first project 20, such as construction workers and/or any other persons observing activity at/of first project 20. First project data 24 can include a plurality of types of project data 24A-24L, first observation data 26 can include a plurality of types of observation data 26A-26J, first incident data can include a plurality of types of incident data 28A-28I, first weather data can include a plurality of types of weather data 30A and 30B, and first worker data can include a plurality of types of worker data 32A-32D. Incident predictor 12 can also be provided information regarding second project 40 at second worksite 42 distinct (e.g., physically remote) from first project 20 and first worksite 22. The information/data from second project 40 can include second project data 44, second observation data 46, second weather data 50, and second worker data 52 (collectively referred to as second data 68 with reference to FIG. 1B). The information/data from second project 40 can be used by incident predictor 12 to predict the likelihood of the occurrence of a future unsafe incident at second project 40. Second observation data 46 can be provided by persons/workers 55 associated with second project 40, such as construction workers and/or any other persons observing activity at/of second project 40. In some configurations, none or only a limited amount of information/data regarding second project 40 is collected and/or provided to incident predictor 12, and the information/data regarding first project 20 can be used to predict the likelihood of an occurrence of a future unsafe incident at second project 55.

The disclosed methods (e.g., processes 100 and/or 200) and systems 10 can include other steps, components, configurations, and/or features not expressly disclosed herein that are suitable for predicting the likelihood of the occurrence of a future unsafe incident at any project. For example, system 10 can include communication means for sending and/or receiving information/data regarding first project 20 and/or second project 40 and/or for sending and/or receiving other information/data from other sources. Further, system 10 can provide the prediction to the necessary persons, computers, etc. via wired or wireless communication. Additionally, system 10 (and associated methods) can receive information/data from more than two projects, and training incident predictor 12 and/or machine-learning model 72 can include receiving information/data from many projects to aid in additional training/refining of the predictive capabilities of system 10.

First project 20 and second project 40 can each be any area, zone, undertaking, and/or activity for which unsafe incidents are intended to be reduced and/or prevented. First project 20 and second project 40 can each be any project known to one in the industry, such as a construction site in which a new building/structure/landscape is being constructed, demolished, and/or altered and/or another type of worksite. Working on or in association with first project 20 can be persons/workers 35, and working on or in association with second project 40 can be persons/workers 55. Workers 35 and/or 55 can be employees of a company operating projects 20 and/or 40, can be employees of a general contractor and/or subcontractor, can be inspectors not otherwise associated with any contracting company, can be the owners of the building/structure/landscape that is being worked on, and/or can be any other persons capable of observing activities associated with first project 20 and/or second project 40. For example, worker 35 and/or 55 can be a plumber subcontracted by a general contractor to install a septic tank on project 20 (e.g., worksite 22) and/or 40 (e.g., worksite 42), respectively. In another example, worker 35 and/or 55 is employed by a general contractor to, among other tasks, perform carpentry duties.

System 10 and related methods are disclosed herein for use in predicting the likelihood of the occurrence of a future unsafe incident. An unsafe incident is an event/activity that causes the need to report the event/activity, at a minimum, to the Occupational Safety and Health Administration (hereinafter, “OSHA”). The unsafe incident can result in injury/damage to persons, property, and/or equipment. In this disclosure, an unsafe incident is distinguished from an unsafe activity. An unsafe incident causes the need to report the event/activity to OSHA, while an unsafe activity causes no need to report the activity (e.g., the activity did not result in damage to persons, property, and/or equipment). For example, an unsafe activity can be worker 35 and/or 55 moving about an elevated platform (e.g., scaffold) without the use of a harness. That unsafe activity can become an unsafe incident if worker 35 and/or 55 falls and, potentially, injures himself/herself. An unsafe incident does not need to arise from an unsafe activity/event. For example, an unsafe incident can be caused by the breaking of a guidewire due to environmental conditions (e.g., cold temperatures, high winds, etc.), even if all precautions were followed and there was no unsafe activity/event. Unsafe incidents can be separated into three categories of severity: an OSHA-recordable incident (the lowest severity); a days away, restricted, or transferred (hereinafter, “DART”) incident, and a lost-time incident (the highest severity). The categorization of unsafe incidents does not need to be limited to these three categories, and other configurations can separate the unsafe incidents into less than or more than the three categories. System 10 and related methods can further be configured to predict the severity of the future unsafe incident, which may be useful in determining if preventative measures are to be implemented to reduce the likelihood of the occurrence of the unsafe incident.

Information/data can be collected about first project 20 and/or second project 40. This information/data can be determined before the start of project 20 and/or 40, during the operation/construction of project 20 and/or 40, and/or at the end of project 20 and/or 40.

One category of information/data regarding first project 20 is first project data 24 and regarding second project 40 is second project data 44. First project data 24 and second project data 44 can have the same types of project data or differing types of project data (and the values of that data can be, and likely is, different as well). Project data 24 and/or 44 can be received by system 10 from any location, such as from a design/engineering firm or other party (distant from projects 20 and/or 40) that planned the activities/operations constituting projects 20 and/or 40.

In the configuration shown in FIG. 1A, first project data 24 can include cost of the project 24A, projected start date 24B, actual start date 24C, projected completion date 24D, size of worksite 24E, location of worksite 24F, contract type 24G, procurement method of the contract 24H, value of the contract 24I, insurance type of a workers' compensation policy 24J, policy holder of the workers' compensation policy 24K, and number of change orders performed at the worksite 24L, while second project data 44 can include cost of the project 44A, projected start date 44B, actual start date 44C, projected completion date 44D, size of worksite 44E, location of worksite 44F, contract type 44G, procurement method of the contract 44H, value of the contract 44I, insurance type of a workers' compensation policy 44J, policy holder of the workers' compensation policy 44K, and number of change orders performed at the worksite 44L. Project data 24 and/or 44 can include less than or more than the plurality of types of data disclosed above. For example, project data 24 and/or 44 can include a type of project data that includes actual completion date of the project, a textual description of the activity observed, and/or other types. Additionally, project data 24 and/or 44 can have blanks in the values for any of the types of data. For example, second project 40 can have second project data 44 that includes a blank in actual start date 44C because operation of second project 40 has yet to begin. Project data 24 and/or 44 can be provided to system 10 at any time, including before projects 20 and/or 40 have begun, during the operation of projects 20 and/or 40, and/or after the completion of projects 20 and/or 40. Furthermore, project data 24 and/or 44 can be provided to system 10 once, multiple times at consistent or inconsistent intervals, or continuously as any values and/or types of project data 24 and/or 44 change.

Another category of information/data regarding first project 20 is first observation data 26 and regarding second project 40 is second observation data 46. First observation data 26 and second observation data 46 can have the same types of observation data or differing types of observation data (and the values of that data can be, and likely is, different as well). Observation data 26 and/or 46 can be received by system 10 from any location, such as from a personal mobile device associated with workers 35 and/or 55 (e.g., workers 35 and/or 55 complete an observation report/entry on a mobile phone), from a computer located on project worksite 20 and/or 40, or from another location on or distant from project 20 and/or 40.

In the configuration shown in FIG. 1A, first observation data 26 (e.g., observation #1 from worker 35) can include date of the observation 26A, date of the entry of the observation 26B, a safety category of the observation 26C with the safety category identifying the observation as one of a safe observation or an unsafe observation, the category of worker performing the activity of the observation 26D, the category of the activity observed 26E, the project with which the observation is associated 26F, the person/worker making the observation 26G, cause of the activity observed 26H, number of observations made on the date of the observation 26I, ratio of safe observations to unsafe observations 26J, day of the week of the date of the observation 26K, difference in time between the date of the observation and the date of recordation of the observation 26L, and difference in time between the date of the observation and the date of corrective action 26M, while second observation data 46 can include date of the observation 46A, date of the entry of the observation 46B, whether the activity of the observation was safe/unsafe 46C, the category of worker performing the activity of the observation 46D, the category of the activity observed 46E, the project with which the observation is associated 46F, the person/working making the observation 46G, cause of the activity observed 46H, number of observations made on the date of the observation 46I, ratio of safe observations to unsafe observations 46J, day of the week of the date of the observation 46K, difference in time between the date of the observation and the date of recordation of the observation 46L, and difference in time between the date of the observation and the date of corrective action 46M. Observation data 26 and/or 46 can include less than or more than the plurality of types of data disclosed above. For example, observation data 26 and/or 46 can include a type of observation data regarding where on the project worksite (e.g., the area) the activity was observed. Additionally, observation data 26 and/or 46 can have blanks in the values of any of the types of data. For example, observation #1 can include a blank in date of entry 26B as the system/worker 35 that submitted/reported the observation did not note date of entry 26B.

Observation data 26 and/or 46 can be created (e.g., a report/entry is filled out) by workers 35 and/or 55 detailing observations of activities at projects 20 and/or 40. Observation data 26 and/or 46 includes multiple entries with each entry being focused on one activity. Each entry can include all of the above listed types of observation data 26A-26M/46A-46M, less than the listed types, or more types of observation data than those listed. Observation data 26 and/or 46 can include multiple entries by the same worker 35 and/or 55 having the same date so the worker can observe multiple activities on the same date. Additionally, one activity can be the focus of multiple entries if the activity was observed by more than one worker 35 and/or 55. Worker 35 and/or 55 can submit/report as many entries as wanted/needed, including one or multiple per day, week, month, etc. However, the more entries of observation data 26 and/or 46, the greater the accuracy of the prediction of the likelihood of a future unsafe incident by system 10. The observations by workers 35 and/or 55 can be of an activity that was safe (e.g., colleague using proper safety equipment) or unsafe (e.g., colleague not wearing a harness when moving about at an elevated height). An unsafe observation may not result in an unsafe incident (e.g., the colleague was not wearing a harness, but the colleague did not fall). Each report/entry can, before being submitted, include observation types having various check boxes, drop-down lines, and automatic fill ins (e.g., date of submittal of entry) to solicit information/data from workers 35 and/or 55.

Observation data 26 and/or 46 can be provided to system 10 at any time, including before projects 20 and/or 40 have begun, during the operation of projects 20 and/or 40, and/or after the completion of projects 20 and/or 40. Furthermore, observation data 26 and/or 46 can be provided to system 10 once, multiple times at consistent or inconsistent intervals, or continuously as individual entries are submitted/reported by workers 35 and/or 55.

Another category of information/data regarding first project 20 (and/or second project 40) is first incident data 28. System 10 can be provided with incident data from second project 40 and/or other projects if such data exists. For example, second project 40 may not have incident data if second project 40 has not had a reported unsafe incident or second project 40 has yet to begin. In the disclosed example in FIG. 1, only first incident data 28 from first project 20 exists and is provided to system 10. First incident data 28 includes information/data about one or multiple reported unsafe incidents that have occurred at first project 20. First incident data 28 is used by system 10 (e.g., incident predictor 12 and/or machine-learning model 14) to train and/or improve the predictive capabilities by providing the dependent variable(s) system 10 is aimed at determining/predicting. First incident data 28 can be received by system 10 from any location, such as from a personal mobile device and/or computer associated with an inspector of first project 20, any worker 35 associated with first project 20, an OSHA official, or another location or person.

In the configuration shown in FIG. 1A, first incident data 28 (e.g., incident data from incident #1) can include date of the incident 28A, severity of the incident 28B, category of the worker involved in the incident 28C, the project at which the incident occurred 28D (e.g., project #1), the category of the activity being performed during the incident 28E, a total number of reported unsafe incidents associated with the first project 28F, a variable indicating the severity of the unsafe incident occurred on the first project on a particular date 28G, a variable indicating if a reported unsafe incident occurred on the first project on a particular date 28H, and a variable indicating if no unsafe incident occurred on the first project on a particular date 28I. First incident data 28 can include other types of data/categories not expressly disclosed herein. Additionally, some of the types of first incident data 28A-28I can have blanks in the values.

Another category of information/data regarding first project 20 is first weather data 30 and regarding second project 40 is second weather data 50. First weather data 30 and second weather data 50 can have the same types of weather data or differing types of weather data (and the values of that data can be, and likely is, different as well). Weather data 30 and/or 50 can be received by system 10 from any location, such as from a weather collection source (e.g., a website of the National Weather Service having weather data at a location of worksites 22 and/or 42), from a personal mobile device associated with workers 35 and/or 55 (e.g., workers 35 and/or 55 complete an weather report/entry on a mobile phone), from a computer located on project worksite 20 and/or 40, or from another location on or distant from project 20 and/or 40.

In the configuration shown in FIG. 1A, first weather data 30 (e.g., weather regarding first project 20) can include current weather data at the first project 30A (e.g., precipitation, wind, temperature, sunlight, etc.), a date of the current weather data at the first project 30B, forecasted weather data at the first project 30C (e.g., the prediction of the precipitation, wind, temperature, sunlight, etc. on a particular date), and a date of the forecasted weather data at the first project 30D, while second weather data 50 can include current weather data at the second project 50A (e.g., precipitation, wind, temperature, sunlight, etc.), a date of the current weather data at the second project 50B, forecasted weather data at the second project 50C (e.g., the prediction of the precipitation, wind, temperature, sunlight, etc. on a particular date), and a date of the forecasted weather data at the second project 50D. Weather data 30 and/or 50 can include less than or more than the plurality of types of data disclosed above. Additionally, weather data 30 and/or 50 can have blanks in the values of any of the types of data. For example, weather data 30 for first project 20 can include a blank in current weather data 30A and the date of the current weather data 30B for a particular date that work was being performed on/at first worksite 22 of first project 20.

Another category of information/data regarding first project 20 is first worker data 32 and regarding second project 40 is second worker data 52. First worker data 32 and second worker data 52 can have the same types of worker data or differing types of worker data (and the values of that data can be, and likely is, different as well). Worker data 32 and/or 52 can be received by system 10 from any location, such as from a personal mobile device associated with workers 35 and/or 55 (e.g., workers 35 and/or 55 complete a report/entry on a mobile phone), from a computer located on project worksite 22 and/or 42, or from another location on or distant from project 20 and/or 40.

In the configuration shown in FIG. 1A, first worker data 32 (e.g., worker data regarding first project 20) can include a number of workers in each worker category on first project on each date 32A (e.g., how many laborers, managers, safety personnel, etc. were on worksite 22 each day that work was being performed), an age of each worker on first project on each date 32B, an amount of experience of each worker on first project on each date 32C, and a total number of workers on first project on each date 32D, while second worker data 52 can include a number of workers in each worker category on second project on each date 52A (e.g., how many laborers, managers, safety personnel, etc. were on worksite 42 each day that work was being performed), an age of each worker on second project on each date 52B, an amount of experience of each worker on second project on each date 52C, and a total number of workers on second project on each date 52D. Worker data 32 and/or 52 can include less than or more than the plurality of types of data disclosed above. Additionally, worker data 32 and/or 52 can have blanks in the values of any of the types of data. For example, worker data 32 for first project 20 can include a blank in an age of each worker on first project on each date 32B for a particular date that work was being performed on/at first worksite 22 of first project 20.

System 10 includes incident predictor 12, which can include and/or implement an edge gateway/device within and/or in communication with projects 20 and/or 40. FIG. 1A shows incident predictor 12 as a cloud-based system distant from projects 20 and 40. However, this is for representation, and incident predictor 12 can be located anywhere within, outside, or distant from projects 20 and/or 40. In one example, a portion or all of incident predictor 12 is located within a server room or office of the company in charge of projects 20 and/or 40. In another example, a portion or all of incident predictor 12 is located at one or both of first project 20 and second project 40. Additionally, incident predictor 12 can be configured to receive information from first project 20, second project 40, any persons/workers 35 and/or 55 associated with projects 20 and/or 40, respectively, and/or other sources of information/data in communication with incident predictor 12. Incident predictor 12 can be configured to give and/or perform instructions and/or analysis necessary to predict the likelihood of an occurrence of an unsafe incident.

As described below, incident predictor 12 can include one or multiple components having any hardware and/or software. As shown in FIG. 1B, incident predictor 12 can include computer processor 60, user interface 62, memory 64 (storing first data 66 from first project 20 and/or second data 68 from second project 40), data linking module 70, and machine-learning model 73 (having extraction module 74 and/or prediction module 76). Incident predictor 12 can have other components not expressly disclosed herein and/or shown in FIG. 1B for receiving information/data and predicting the likelihood of the occurrence of a future unsafe incident at any project. Incident predictor 12 can be designed/organized in any configuration to perform the functions described herein. Incident predictor 12 can accept data from and/or can be operably connected to any data source regarding any project, such as first project 20 and/or second project 40.

Incident predictor 12 can be a discrete assembly or be formed by one or more devices capable of individually or collectively implementing functionalities and generating and outputting data as discussed herein. In some examples, incident predictor 12 can be implemented as a plurality of discrete circuitry subassemblies. In some examples, incident predictor 12 can include or be implemented at least in part as a smartphone or tablet, among other options. In some examples, incident predictor 12 can include and/or be implemented as downloadable software in the form of a mobile application. The mobile application can be implemented on a computing device, such as a personal computer, tablet, or smartphone, among other suitable devices. Incident predictor 12 can be considered to form a single computing device even when distributed across multiple component devices.

Incident predictor 12 can include one or multiple computer/data processors 60. In general, computer/data processors 60 can include any or more than one of a processor, a microprocessor, a controller, a digital signal processor (DSP), an application specific integrated circuit (ASIC), a field-programmable gate array (FPGA), or other equivalent discrete or integrated logic circuitry. Computer processor 60 can perform instructions stored within storage media, such as memory 64 (or located elsewhere), and/or computer processor 60 can include storage media such that computer processor 60 is able to store instructions and perform the functions described herein. Additionally, computer processor 60 can perform other computing processes described herein as merely being performed by system 10.

Incident predictor 12 can include user interface 62, which can be an input and/or output device. User interface 62 can enable an operator to control operation of system 10 and/or incident predictor 12. For example, user interface 62 can be configured to receive inputs from an operator and/or provide outputs. User interface 62 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

Memory 64 is configured to store information and, in some examples, can be described as a computer-readable storage medium. Memory 64, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 64 is a temporary memory. As used herein, a temporary memory refers to a memory having a primary purpose that is not long-term storage. Memory 64, in some examples, is described as volatile memory. As used herein, a volatile memory refers to a memory that that the memory does not maintain stored contents when power to memory 64 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on incident predictor 12 (e.g., by a computer-implemented machine-learning model 72 and/or data linking module 70) to temporarily store information during program execution.

Memory 64, in some examples, also includes one or more computer-readable storage media. Memory 64 can be configured to store larger amounts of information than volatile memory. Memory 64 can further be configured for long-term storage of information. In some examples, memory 64 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories. As shown in the example of incident predictor 12 in FIG. 1B, memory 64 can store first data 66, second data 68, and/or data from other sources for training machine-learning module 72 and/or for predicting the likelihood of the occurrence of a future unsafe incident at any of the projects of interest. Additionally, memory 64 can store predictive features, which are those features (e.g., types of project data, observation data, weather data, and/or worker data) that are most indicative of the occurrence of a future unsafe incident at any of the project.

Incident predictor 12 can also include data linking module 70, which can be incorporated into any of the other components of incident predictor 12, such as processor 60 and/or machine-learning model 72. Data linking module 70 can include any software and/or hardware for performing the instructions and/or functions described herein. Data linking module 70 can access first data 66 and/or second data 68 in memory 64 and/or can perform instructions stored by incident predictor 12 to evaluate and/or manipulate first data 66 and/or second data 68.

Data linking module 70 can organize the information/data for more optimal use in training system 10 (e.g., machine-learning module 72) and/or in predicting future unsafe incidents. Observation data 26 and/or 46 can be a combination of multiple entries of observations of activity, with each of the observations being on a specific date. Similarly, incident data 28 can be a combination of multiple entries of unsafe incidents occurring on a specific date, weather data 30 and/or 50 can be a combination of multiple entries of current weather and forecasted weather on a one or each date that work is being performed, and worker data 32 and/or 52 can be a combination of multiple entries regarding the workers on first project 20 and/or second project 40, respectively, for one or each date that work is being performed. Observation data 26/46, weather data 30/50, and/or worker data 32/52 can be linked/associated with incident data 28 via the date of the observation, the date of the recorded weather/forecast, the date of the worker data, and the date of the reported unsafe incident. This allows for observation data 26/46, weather data 30/50, and/or worker data 32/52 that is associated with a reported unsafe incident/incident data 28 as well as observation data 26/46, weather data 30/50, and/or worker data 32/52 that is associated with no unsafe incident (e.g., the observations of activities, weather, and worker data that were on dates in which no reported unsafe incident occurred). Thus, this organization provides a data set for training having some types of observation data 26A-26M, weather data 30A-30D, and worker data 32A-332D that are more indicative of the occurrence of the reported unsafe incident and some types of observation data 26A-26M, weather data 30A-30D, and worker data 32A-32D that are less (or not at all) indicative of the occurrence of the reported unsafe incident. Additionally, as project data 24 and/or 44 is received (as well as incident data), system 10 (e.g., machine-learning model 72) can determine the features (e.g., types of project data) that are most and least indicative of the occurrence of a reported unsafe incident. This determination can be used by system 10 to predict future unsafe incidents.

Information/data can be organized by system 10 (e.g., by data linking module 70 and/or another component of incident predictor 12) other ways for more optimal use in training and predicting. For example, all data/information can be compressed such that all incident data 28 having the same date of incident 28A, all observation data 26 having the same date of observation 26A is combined (even if the observation occurred on a date in which no unsafe incident occurred), all weather data 30 having the same date of the current weather data 32B and/or the same date of the forecasted weather data 32D is combined, and/or all worker data 32 having the same date is combined. Such a compression can reorganize observation data 26, weather data 30, and/or worker data 32 from a “yes-no” entry into a “number of yeses/number of nos” entry. For example, before the compression, one entry of observation data 26 may include answers to the following questions: was the observation of a safe or unsafe activity (check box in front of safe or unsafe), what was the category of worker (check box in front of one of a defined category of worker), etc. After the compression, one entry of observation data 26 would include all entries of observations occurring on the same date, with the entry potentially including the following: number of observations on the respective date that are of a safe activity, number of observations that are of an unsafe activity, number of observations involving a category of worker that is a plumber, number of observations involving a category of worker that is a crane operator, etc. A similar reorganization can be performed on incident data 28 by compressing all incident data 28 having the same date of incident 28A into one entry. This reorganizing can reduce the number of overall entries of observation data 26, incident data 28, weather data 30, and/or worker data 32 while correctly representing the types of observation data 26, weather data 30, and/or worker data 32 that may be most indicative of an unsafe incident. System 10 can use other methods of reorganizing and/or optimizing project data 24/44, observation data 26/46, incident data 28, weather data 30/50, and/or worker data 32/52 for use in training and predicting the likelihood of a future unsafe incident.

System 10 (e.g., incident predictor 12) can also infer information/data from project data, observation data, weather data, and/or worker data. For example, inferred information can be whether an ongoing project is on schedule to be completed on time. This information can be inferred from the projected start date of the project, the actual start date of the project, the projected completion date of the project, and/or the current date at which the inference is being determined. The inferred information/data can be features that are determined to be most indicative of the likelihood of the occurrence of an unsafe incident, and the inferred information can be categorized as a type of project data, a type of observation data, a type of weather data, and/or a type of worker data as discussed above that is combined with other entries, evaluated, and/or manipulated as described in this disclosure with regards to other types of project data, observation data, weather data, and/or worker data. The creation of the inferred information/types of data can be by any component of system 10, including processor 60, data linking module 70, and/or machine-learning model 72 of incident predictor 12.

Incident predictor 12 can include one (or multiple) machine-learning model 72, which can include extraction module 74 as well as prediction module 76. Machine-learning model 64 can be either one or multiple separate components and/or within or part of other components of incident predictor 12, such as processor 60 and/or data linking module 70). Machine-learning model 72 can be trained using inputs, such as first project data 24, first observation data 26, first weather data 30, and/or first worker data 32 and outputs, such as first incident data 28. This information/data can be received by system 10 from various sources associated with first project 20 (and/or other projects used for training system 10).

Machine-learning model 72 can perform various techniques to create an algorithm (or multiple algorithms) or otherwise determine which inputs (e.g., the types of project data, observation data, weather data, and/or worker data, which can include inferred information/data) are most indicative of predicting the outputs (e.g., unsafe incidents). These techniques can include classification techniques (e.g., support vector machines, discriminant analysis, naïve bayes, nearest neighbor), regression techniques (e.g., linear regression, GLM, SVR, GPR, ensemble methods, decision trees, random decision forest, random forest, neural networks), clustering (e.g., K-means, K-medoids, fuzzy C-means, hierarchical, Gaussian mixture, neural networks, hidden Markov models), and/or other techniques, such as extreme gradient boosting (XGBoost), logistic regression, and time series forecasting. The machine-learning model 72 can determine and/or weight the importance of each input using coefficients that are increased and/or decreased to refine the accuracy of the prediction by machine-learning model 72. Other techniques and/or methods of training machine-learning model 72 can be used by system 10 and/or incident predictor 12 (or by other components distinct from system 10 responsible for training machine-learning model 72) to train machine-learning models 72.

Once trained, incident predictor 12 (machine-learning model 14) first receives inputs regarding a project, such as project data, observation data, weather data, and/or worker data. Then, extraction module 74 extracts features that are most indicative of the occurrence of an unsafe incident. The features can include the types of project data, the types of observation data, the types of weather data, and/or the types of worker data, which can also include information inferred from that data. The specific types of project data, observation data, weather data, and/or worker data that are most indicative of the occurrence of an unsafe incident are determined during training of machine-learning model 72. After extraction of the features by extraction module 74, prediction module 76 uses the features; which can be types of project data, types of observation data, types of weather data, and/or types of worker data; that are most indicative of the occurrence of an unsafe incident to predict the likelihood of the occurrence of the future unsafe incident. As detailed above, this can be performed by prediction module 76 using any technique, including one that weights the importance of the different types of data.

Incident predictor 12 can be trained using information/data from first project 20 to predict the likelihood of the occurrence of a future unsafe incident at first project 20 (if first project 20 has not yet been completed). Additionally, after being trained on information/data associated with first project 20 and/or other projects, incident predictor 12 can receive information/data from second project 40; such as second project data 44, second observation data 46, second weather data 50, and/or second worker data 52; and use that information/data to predict the likelihood of the occurrence of a future unsafe incident at second project 40. Similarly, incident predictor 12 can receive information/data from another project (e.g., projects not expressly shown in FIG. 1A) and use that information/data to predict the likelihood of the occurrence of a future unsafe incident at that respective project.

System 10 (e.g., incident predictor 12) can receive additional first incident data 28 and/or other incident data from other projects to further train/refine the predictive capabilities of system 10. This further training/refining can be done continuously and/or periodically in real time as the incident data is received by system 10. The training/refining can improve the accuracy of predictions by system 10.

The prediction of the likelihood of the occurrence of a future unsafe incident by system 10/incident predictor 12 can come in a variety of outputs/forms, such as a percentage of likelihood that the future unsafe incident will occur (with 0% being that an unsafe incident will not occur and 100% being that the unsafe incident will occur), a value between 0 and 1 (with 0 being that an unsafe incident will not occur and 1 being that the unsafe incident will occur), or other outputs. Additionally, system 10/incident predictor 12 can predict (and the output can display a prediction of) how many future unsafe incidents are to occur throughout the entirety of the project, the severity of those future unsafe incidents, and other predictions/outputs. In one example, system 10/incident predictor 12 can output the likelihood of the occurrence of a future unsafe incident at second project 40 of 0.78, meaning that it is more likely than not that at least one unsafe incident will occur at second project 40. If the number is less than 0.55, than it is less likely than not that at least one unsafe incident will occur at second project 40. In another example, system 10/incident predictor 12 can output a prediction that the likelihood that an OSHA-recordable unsafe incident will occur at second project 40 is 0.93, the likelihood that a DART unsafe incident will occur at second project 40 is 0.28, and the likelihood that a lost-time unsafe incident will occur at second project 40 is 0.06. In a further example, system 10/incident predictor 12 can output a prediction that the likelihood that one unsafe incident will occur at second project 40 is 0.85, that two unsafe incidents will occur at second project 40 is 0.67, that three unsafe incidents will occur at second project 40 is 0.35, etc. System 10 can also tailor/limit the timespan of the prediction. For example, the prediction can be in the form of predicting the likelihood of a future unsafe incident occurring within the next 60 days, the next 180 days, the next year, etc.

By receiving first project data 24, first observation data 26, first incident data 28, first weather data 30, and/or first worker data 32, system 10/incident predictor 12 can determine which features are most indicative of the occurrence of the previous unsafe incident as detailed in first incident data 28A-28E with the features possibly including the types of first project data 24A-24L, the types of first observation data 26A-26M, the types of first weather data 30A-30D, and/or the types of worker data 32A-32D. The predictive capabilities can be increased/refined if more incident data from first project 20, second project 40, and/or other projects is received (along with corresponding project data, observation data, weather data, and/or worker data). The predictive capabilities can then be used with other projects to predict the likelihood of a future unsafe incident at first project 20, second project 40, or another project.

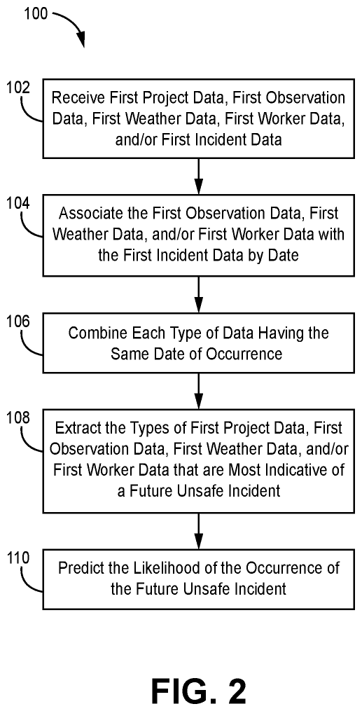

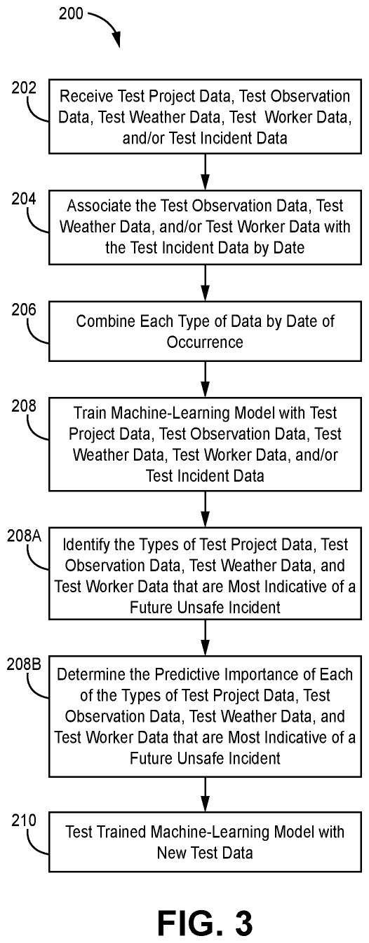

System 10/incident predictor 12 can perform various methods of predicting the likelihood of an unsafe incident occurring at first project 20, second project 40, or any other projects. System 10 can also perform various methods for training incident predictor 12 (e.g., machine-learning model 72) to improve the predictive capabilities. The methods for training and predicting are shown in FIGS. 2 and 3, respectively, and can include other steps not expressly disclosed herein and/or can include the steps in any order.

FIG. 2 is a flow diagram of example process 100 of predicting the likelihood of the occurrence of a future unsafe incident at first project 20. While process 100 is described herein as being used with regards to first project 20 and the prediction of the likelihood of an occurrence of a future unsafe incident at first project 20, process 100 can be used with regards to any project, including second project 40.

First, process 100 includes step 102, which is receiving first project data 24, first observation data 26, first weather data 30, first worker data 32, and/or first incident data 28 from first project 20. First project data 24 can include any of the above disclosed types of first project data 24A-24L (and/or other types), first observation data 26 can include any of the above disclosed types of first observation data 26A-26M (and/or other types), first weather data 30 can include any of the above disclosed types of first weather data 30A-30D (and/or other types, first worker data 32 can include any of the above disclosed types of first worker data 32A-32D (and/or other types), and first incident data 28 can include any of the above disclosed types of incident data 28A-28I (and/or other types of data). The project data, observation data, weather data, worker data, and incident data can be received by incident predictor 12 (and/or other components of system 10) and stored in memory 64 (or another storage media).

Next, process 100 can include step 104, which is associating first observation data 26, first weather data 30, and/or first worker data 32 with first incident data 28 by linking the date of the occurrence (e.g., the date of observation, the date of the current weather, the date of the forecasted weather, the date regarding the number and type of workers on the project, etc.) for each entry to the date of the reported unsafe incident of each entry/incident. Step 104 can also include created inferred data/information from first project data 24, first observation data 26, first weather data 30, and/or first worker data 32. This inferred information can be stored and used like any other type of project data, observation data, weather data, and/or worker data described herein. Step 104 can be performed by data linking module 70 and/or any other component of system 10/incident predictor 12 as detailed above with regards to FIGS. 1A and 1B.

Process 100 can also include step 106, which is combining each type of first observation data 26A-26M having the same date of observation/occurrence 26A, combining each type of first weather data 30A-30D having the same date of occurrence, combining each type of worker data 32A-32D having the same date of occurrence, and/or combining each type of first incident data 28A-28I having the same date of incident 28A. Step 106, which can be performed by data linking module 70 and/or other components of incident predictor 12, allows for the compression and/or reorganization of observation data, weather data, worker data, and/or incident data for potentially easier and/or more suitable use by machine-learning model 72.

By associating first observation data 26, first weather data 30, and/or first worker data 32 with first incident data 28, system 10 and/or process 100 can then perform/include step 108, which is extracting (via extraction module 74 of machine-learning model 70 and/or other components of system 10/incident predictor 12) the features (e.g., the types of first project data 24, observation data 26, weather data 30, and/or worker data 32) that are most indicative of the occurrence of the reported unsafe incident. The specific features that are extracted in step 106 are determined during training of machine-learning model 72, with an example process shown in FIG. 3.

Then, from those features that are most indicative of the occurrence of the reported unsafe incident as extracted in step 108, process 100 can perform step 110, which is predicting the likelihood of the occurrence of a future unsafe incident. Step 110 can include the use of features that include types of first observation data 26A-26M, types of first project data 24A-24L, types of first weather data 30A-30D, and types of first worker data 32A-32D (if predicting the likelihood of a future unsafe incident at first project 20), features that include types of second observation data 46A-26M, types of second project data 44A-44L, types of second weather data 50A-50D, and types of second worker data 52A-52D (if predicting the likelihood of a future unsafe incident at second project 40), and/or features that include types of observation data, project data, weather data, and worker data from another project (if predicting the likelihood of a future unsafe incident at another project). Thus, in another example of process 100, system 10/incident predictor 12 can receive second project data 44, second observation data 46, second weather data 50, and second worker data 52 and, from the features that were previously found to be most indicative of the occurrence of a future unsafe incident with regards to first project 20, can predict the likelihood of the occurrence of a future unsafe incident at second project 40.

FIG. 3 is a flow diagram of example process 200 of training machine-learning model 72 to predict the likelihood of the occurrence of a future unsafe incident. Process 200 is described herein as using data received from first project 20 (first project data 24, first observation data 26, first incident data 28, first weather data 30, and first worker data 32) as test data to train machine-learning model 72. However, process 200 can use any data received from any project to train machine-learning model 72 as long as the data includes incident data as well as corresponding project data, observation data, weather data, and/or worker data.

Process 200 can include steps 202, 204, and 206, which are similar to steps 102, 104, and 106 of process 100. Step 202 includes receiving test project data, test observation data, test weather data, test worker data, and/or test incident data, which can be first data 66 from first project 20 (including first project data 24, first observation data 26, first incident data 28, first weather data 30, and/or first worker data 32). The test data can be received by incident predictor 12 (and/or other components of system 10) and stored in memory 64 (or another storage media). Step 204 includes associating the test observation data, the test weather data, and/or the test worker data with the test incident data by linking the date of occurrence for each entry to the date of the reported unsafe incident of each entry/incident. Step 204 can be performed by data linking module 70 and/or any other component of system 10/incident predictor 12 as detailed above with regards to FIGS. 1A and 1B. Step 206 includes combining each type of test observation data, each type of weather data, and/or each type of worker data having the same date of occurrence/observation/collection and/or combining each type of incident data having the same date of incident. Step 204 can also include creating inferred test data from test project data, test observation data, test weather data, and/or test worker data. Step 204 can be performed by data linking module 70 and/or other components of incident predictor 12, and can allow for the compression and/or reorganization of the test observation data, the test weather data, the test worker data, and/or test incident data for potentially easier and/or more suitable use in training machine-learning model 72.

Next, process 200 includes step 208, which includes training machine-learning model 72 with test project data, test observation data, test weather data, test worker data, and/or test incident data. Step 208 can be performed by machine-learning model 72, by processor 60, by another component of incident predictor 12, and/or by another component of system 10. Additionally, other configurations can include a separate system distinct from system 10 that trains machine-learning model 72 and provides the trained machine-learning model 72 to system 10 and/or incident predictor 12.

Step 208 can be performed using any technique for training a machine-learning model, such as those described above with regards to FIGS. 1A and 1B. In example process 200, training machine-learning model 72 in step 208 can include two sub-steps 208A and 208B. Step 208A includes identifying, by machine-learning model 72, the features that are most indicative of the occurrence of an unsafe incident (with the unsafe incidents being reported unsafe incidents in test incident data). These features can include the types of test project data, the types of test observation data, the types of test weather data, and/or the types of test worker data that are most indicative of the occurrence of an unsafe incident. In step 208A, the machine-learning model determines which inputs (features that can include project data, observation data, weather data, and/or worker data) are most indicative of predicting the outputs (unsafe incidents). The features (e.g., the types of project data, observation data, weather data, and/or worker data that are most indicative of the likelihood of the occurrence of the unsafe incident) can be stored/saved by machine-learning model 72 and/or incident predictor 12 for use once machine-learning model 72 is implemented/operational within system 10.

Step 208B includes determining, by machine-learning model 72, the predictive importance of each of the features that are identified as being the most indicative of the occurrence of the unsafe incident in step 208A. Step 208B can also include weighing the importance of each feature/input using coefficients that are increased and/or decreased to refine the accuracy of the prediction by machine-learning model 72 by placing more or less importance on the features that are more or less indicative of the occurrence of an unsafe incident. This determination of importance (e.g., the adjusting of coefficients associated with the features, such as the types of project data, observation data, weather data, and/or worker data) can be stored/saved by machine-learning model 72 and/or incident predictor 12 for use once machine-learning model 72 is implemented/operational within system 10.

After training machine-learning model 72 in step 208, process 200 can include step 210, which is testing the trained machine-learning model with new test data and/or with test data that has not previously been used to train machine-learning model 72. Step 210 can include repeating all of process 200 (e.g., steps 202-208) once or multiple times and/or repeating a subset of process 200 (e.g., steps 204-208). Testing the trained machine-learning model 210 can also include reperforming steps 208 to refine the predictive capabilities of machine-learning model 210 by refining which features (e.g., which types of project data, observation data, weather data, and/or worker data) are identified/extracts as well as refining the importance/weights of those features in predicting the likelihood of the occurrence of a future unsafe incident.

System 10 can also include a method of predicting the severity of a future unsafe incident in a similar fashion to the prediction of the likelihood of the occurrence of a future unsafe incident by determining the types of project data, the types of observation data, the types of weather data, and/or the types of worker data that are most indicative of a particular severity of an unsafe incident. As detailed above, system 10, including incident predictor 12, can include other configurations, capabilities, and functions not expressly disclosed herein. The systems and methods disclosed herein provide significant advantages for predicting the likelihood of the occurrence of a future unsafe incident at a project worksite.

The following are nonlimiting examples of the system and related processes for predicting the likelihood of the occurrence of a unsafe incident:

A method of predicting the likelihood of an unsafe incident occurring at a first worksite of a first project can include receiving first project data that includes at least one of the following types: a cost of the first project, a projected start date of the first project, an actual start date of the first project, a projected completion date of the first project, a size of the first worksite of the first project, a location of the first worksite, a contract type of a contract under which work at the first worksite is performed, a procurement method of the contract, a value of the contract, an insurance type of a workers' compensation policy covering work performed at the first project, a policy holder of the workers' compensation policy, and a number of change orders performed at the first worksite. The method can also include receiving first observation data that includes at least one of the following types: a date of the observation, a safety category of the observation with the safety category identifying the observation as one of a safe observation or an unsafe observation, a category of worker that was observed, a category of activity that was observed, a cause of the activity that was observed, a number of observations made on the date of the observation, a ratio of safe observations to unsafe observations, a day of week of the date of the observation, a difference in time between the date of the observation and a date of recordation of the observation, and a difference in time between the date of the observation and a date of corrective action. The method can also include receiving first incident data that includes at least one of the following types: a date of a reported unsafe incident associated with the first project, a severity of the unsafe incident, a category of worker associated with the unsafe incident, a project associated with the unsafe incident, a category of activity associated with the unsafe incident, a total number of reported unsafe incidents associated with the first project, a first variable indicating if the reported unsafe incident occurred on the project on a particular date, a second variable indicating the severity of the reported unsafe incident occurring on the project on a particular date, and a third variable indicating if no reported unsafe incident occurred on the project on a particular date. The method can also include, from features that include at least one of the types of first observation data and the types of first project data that are most indicative of the occurrence of the reported unsafe incident, predicting, by an incident predictor, the likelihood of an occurrence of a first future unsafe incident at the first project.

The method can further include receiving first worker data that includes at least one of the following types: a number of workers in each worker category on the first worksite on each date, an age of the worker on the first worksite on each date, amount of experience of each worker on the first worksite on each date, and a total number of workers on the first worksite on each date.

The method can further include receiving first weather data that includes at least one of the following types: current weather data, a date of the current weather data, forecasted weather data, and a date of the forecasted weather data.

The method can further include that predicting the likelihood of the occurrence of the first future unsafe incident is determined from features that include at least one of the types of first observation data, the types of first project data, the types of first worker data, and the types of first weather data that are most indicative of the occurrence of the reported unsafe incident.

The method can further include that the step of predicting the likelihood of the occurrence of the first future unsafe incident at the first project further comprises associating the first observation data with the first incident data by linking the date of the observation to the date of the reported unsafe incident, associating the first worker data with the first incident data by linking each date for which first worker data is received to the date of the reported unsafe incident, associating the first weather data with the first incident data by linking each date for which first weather data is received to the date of the reported unsafe incident, and identifying, by the computer processor, the features that are most indicative of the occurrence of the reported unsafe incident

The method can further include that the step of predicting the likelihood of the occurrence of the first future unsafe incident at the first project further comprises associating the first observation data with the first incident data by linking the date of the observation to the date of the reported unsafe incident and identifying, by the computer processor, the features that are most indicative of the occurrence of the reported unsafe incident.

The method can further include that the step of identifying the features that are most indicative of an occurrence of the reported unsafe incident is performed by a machine-learning model.

The method can further include determining, by the machine-learning model, an importance of each of the features to the occurrence of the first future unsafe incident and weighting the features accordingly in predicting the likelihood of the occurrence of the first future unsafe incident.

The method can further include that the machine-learning model uses a random forest technique, an extreme gradient boosting technique, or a time series forecasting technique to identify the first observation data and the first project data that are most indicative of the occurrence of the reported unsafe incident.

The method can further include that the first observation data includes the date of the observation and the method can combine each type of the first observation data corresponding to first observation data that have the same date of the observation.

The method can further include that the type of features that are most indicative of the occurrence of the reported unsafe incident are saved by the incident predictor as predictive features.

The method can further include receiving second project data and second observation data from a second project physically remote from the first project and, from the features that include at least one of the types of observation data and the types of project data that are identified as predictive features, predicting the likelihood of an occurrence of a second future unsafe incident at the second project.

The method can further include that the first incident data includes the severity of the incident, with the severity of the incident being one of the following: an Occupational Safety and Health Administration-recordable incident, a Days Away Restricted or Transferred-incident, and a lost-time incident.

The method can further include predicting, by the computer processor, the severity of the first future unsafe incident.

A system for predicting the likelihood of an unsafe incident occurring at a first worksite of a first project can include first project data that includes at least one of the following types: a cost of the first project, a projected start date of the first project, an actual start date of the first project, a projected completion date of the first project, a size of the first worksite of the first project, a location of the first worksite, a contract type of a contract under which work at the first worksite is performed, a procurement method of the contract, a value of the contract, an insurance type of a workers' compensation policy covering work performed at the first project, a policy holder of the workers' compensation policy, and a number of change orders performed at the first worksite. The system can also include first observation data that includes at least one of the following types: a date of the observation, a safety category of the observation, the safety category identifying the observation as one of a safe observation or an unsafe observation, a category of worker that was observed, a category of activity that was observed, a cause of the activity that was observed, a number of observations made on the date of the observation, a ratio of safe observations to unsafe observations, day of week of the date of the observation, a difference in time between the date of the observation and a date of recordation of the observation, and a difference in time between the date of the observation and a date of corrective action. The system can also include first incident data that includes at least one of the following types: a date of a reported unsafe incident associated with the first project, a severity of the unsafe incident, a category of worker associated with the unsafe incident, a project associated with the unsafe incident, a category of activity associated with the unsafe incident, a total number of reported unsafe incidents associated with the first project, a first variable indicating if the reported unsafe incident occurred on the project on a date, a second variable indicating the severity of the reported unsafe incident occurring on the project on a date, and a third variable indicating if no reported unsafe incident occurred on the project on a date. The system can also include an incident predictor, which includes a computer processor, configured to receive the first project data, the first observation data, and the first incident data and predict, from features that include at least one of the types of first observation data and the types of first project data that are most indicative of the occurrence of the reported unsafe incident, the likelihood of an occurrence of a first future unsafe incident at the first project.

The system can further include first worker data that includes at least one of the following types: a number of workers in each worker category on the first worksite on each date, an age of the worker on the first worksite on each date, an amount of experience of each worker on the first worksite on each date, and a total number of workers on the first worksite on each date.

The system can further include first weather data that includes at least one of the following types: current weather data, a date of the current weather data, forecasted weather data, and a date of the forecasted weather data, wherein the incident predictor is configured to receive the first project data, the first observation data, the first worker data, the first weather data, and the first incident data and predict, from features that include at least one of the types of first observation data, the types of first project data, the first worker data, and the first weather data that are most indicative of the occurrence of the reported unsafe incident, the likelihood of an occurrence of a first future unsafe incident at the first project.

The system can further include a data linking module configured to associate the first observation data with the first incident data by linking the date of the observation to the date of the reported unsafe incident and determine the type of first observation data and the type of first project data that are most indicative of the occurrence of the reported unsafe incident.

The system can further include that the incident predictor includes a machine-learning module configured to extract the features from the types of first project data and the types of first observation data that are identified by the machine-learning module as being most indicative of the occurrence of the first future unsafe incident.

The system can further include that the machine-learning model is configured to determine an importance of each feature and weigh the features accordingly in predicting the likelihood of the occurrence of the first future unsafe incident.

The system can further include memory in communication with the incident predictor for storing the first project data, the first observation data, and the first incident data.

A method of predicting the likelihood of a future unsafe incident occurring at a first worksite of a first project can include receiving first project data associated with the first project and first observation data associated with the first project, the first project data having a plurality of types of project data and the first observation data having a plurality of types of observation data, extracting, by an incident predictor that includes a machine-learning model, features from the types of project data and the types of observation data that are most indicative of the occurrence of the future unsafe incident at the first worksite of the first project, and predicting, by the machine-learning model and dependent upon predictive features that are most indicative of the occurrence of a future unsafe incident, the likelihood of the future unsafe incident occurring at a first worksite of a first project. The extraction can include receiving second project data associated with a second project, the second project data includes the plurality of types of project data having different values of project data as compared to the first project data; receiving second observation data associated with the second project, the second observation data includes the plurality of types of observation data having different values of observation data as compared to the first observation data; receiving second incident data associated with the second project, the second incident data includes incident data regarding unsafe incidents and safe incidents at the second project; associating the second observation data with the first incident data by linking a date of the observation data to a date of the unsafe incidents; and identifying the predictive features that include the plurality of types of project data and the plurality of types of observation data that are most indicative of an occurrence of the unsafe incident at the second project.

The method can further include that the step of predicting the likelihood of the future unsafe incident occurring at the first worksite further comprises determining an importance of each of the features to the occurrence of the future unsafe incident and weighting the features accordingly in predicting the likelihood of the occurrence of the future unsafe incident.

The method can further include that the machine-learning model uses a random forest technique, an extreme gradient boosting technique, or a time series forecasting technique to identify the predictive features that are most indicative of the occurrence of the unsafe incident at the second project.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of predicting the likelihood of an unsafe incident occurring at a first worksite of a first project, the method comprising:
receiving first project data that includes at least one of the following types:
a cost of the first project;
a projected start date of the first project;
an actual start date of the first project;
a projected completion date of the first project;
a size of the first worksite of the first project;
a location of the first worksite;
a contract type of a contract under which work at the first worksite is performed;
a procurement method of the contract;
a value of the contract;
an insurance type of a workers' compensation policy covering work performed at the first project;
a policy holder of the workers' compensation policy; and
a number of change orders performed at the first worksite;
receiving first observation data that includes at least one of the following types:
a date of the observation;
a safety category of the observation, the safety category identifying the observation as one of a safe observation or an unsafe observation;
a category of worker that was observed;
a category of activity that was observed;
a cause of the activity that was observed;
a number of observations made on the date of the observation;
a ratio of safe observations to unsafe observations;
a day of week of the date of the observation;
a difference in time between the date of the observation and a date of recordation of the observation; and
a difference in time between the date of the observation and a date of corrective action;
receiving first incident data that includes at least one of the following types:
a date of a reported unsafe incident associated with the first project;
a severity of the unsafe incident;
a category of worker associated with the unsafe incident;
a project associated with the unsafe incident;
a category of activity associated with the unsafe incident;
a total number of reported unsafe incidents associated with the first project;
a first variable indicating if the reported unsafe incident occurred on the project on a particular date;
a second variable indicating the severity of the reported unsafe incident occurring on the project on a particular date; and
a third variable indicating if no reported unsafe incident occurred on the project on a particular date; and
from features that include at least one of the types of first observation data and the types of first project data that are most indicative of the occurrence of the reported unsafe incident, predicting, by an incident predictor, the likelihood of an occurrence of a first future unsafe incident at the first project.

2. The method of claim 1, further comprising:
receiving first worker data that includes at least one of the following types:
a number of workers in each worker category on the first worksite on each date;
an age of the worker on the first worksite on each date;
an amount of experience of each worker on the first worksite on each date; and
a total number of workers on the first worksite on each date;
receiving first weather data that includes at least one of the following types:
current weather data;
a date of the current weather data;
forecasted weather data; and
a date of the forecasted weather data;
wherein predicting the likelihood of the occurrence of the first future unsafe incident is determined from features that include at least one of the types of first observation data, the types of first project data, the types of first worker data, and the types of first weather data that are most indicative of the occurrence of the reported unsafe incident.

3. The method of claim 2, wherein the step of predicting the likelihood of the occurrence of the first future unsafe incident at the first project further comprises:
associating the first observation data with the first incident data by linking the date of the observation to the date of the reported unsafe incident;
associating the first worker data with the first incident data by linking each date for which first worker data is received to the date of the reported unsafe incident;
associating the first weather data with the first incident data by linking each date for which first weather data is received to the date of the reported unsafe incident; and
identifying, by the computer processor, the features that are most indicative of the occurrence of the reported unsafe incident.

4. The method of claim 1, wherein the step of predicting the likelihood of the occurrence of the first future unsafe incident at the first project further comprises:
associating the first observation data with the first incident data by linking the date of the observation to the date of the reported unsafe incident; and
identifying, by the computer processor, the features that are most indicative of the occurrence of the reported unsafe incident.

5. The method of claim 4, wherein the step of identifying the features that are most indicative of an occurrence of the reported unsafe incident is performed by a machine-learning model, and the method further comprises:
determining, by the machine-learning model, an importance of each of the features to the occurrence of the first future unsafe incident and weighting the features accordingly in predicting the likelihood of the occurrence of the first future unsafe incident.

6. The method of claim 5, wherein the machine-learning model uses a random forest technique, an extreme gradient boosting technique, or a time series forecasting technique to identify the first observation data and the first project data that are most indicative of the occurrence of the reported unsafe incident.

7. The method of claim 2, wherein the first observation data includes the date of the observation, and the method further comprises:
combining each type of the first observation data corresponding to first observation data that have the same date of the observation.

8. The method of claim 1, wherein the type of features that are most indicative of the occurrence of the reported unsafe incident are saved by the incident predictor as predictive features.

9. The method of claim 8, further comprising:
receiving second project data and second observation data from a second project physically remote from the first project; and
from the features that include at least one of the types of observation data and the types of project data that are identified as predictive features, predicting the likelihood of an occurrence of a second future unsafe incident at the second project.

10. The method of claim 1, wherein the first incident data includes the severity of the incident, with the severity of the incident being one of the following: an Occupational Safety and Health Administration-recordable incident, a Days Away Restricted or Transferred-incident, and a lost-time incident.

11. The method of claim 10, further comprising:
predicting, by the computer processor, the severity of the first future unsafe incident.

12. A system for predicting the likelihood of an unsafe incident occurring at a first worksite of a first project, the system comprising:
first project data that includes at least one of the following types:
a cost of the first project;
a projected start date of the first project;
an actual start date of the first project;
a projected completion date of the first project;
a size of the first worksite of the first project;
a location of the first worksite;
a contract type of a contract under which work at the first worksite is performed;
a procurement method of the contract;
a value of the contract;
an insurance type of a workers' compensation policy covering work performed at the first project;
a policy holder of the workers' compensation policy; and
a number of change orders performed at the first worksite;
first observation data that includes at least one of the following types:
a date of the observation;
a safety category of the observation, the safety category identifying the observation as one of a safe observation or an unsafe observation;
a category of worker that was observed;
a category of activity that was observed;
a cause of the activity that was observed;
a number of observations made on the date of the observation;
a ratio of safe observations to unsafe observations;
a day of week of the date of the observation;
a difference in time between the date of the observation and a date of recordation of the observation; and
a difference in time between the date of the observation and a date of corrective action;
first incident data that includes at least one of the following types:
a date of a reported unsafe incident associated with the first project;
a severity of the unsafe incident;
a category of worker associated with the unsafe incident;
a project associated with the unsafe incident;
a category of activity associated with the unsafe incident;
a total number of reported unsafe incidents associated with the first project;
a first variable indicating if the reported unsafe incident occurred on the project on a date;
a second variable indicating the severity of the reported unsafe incident occurring on the project on a date; and
a third variable indicating if no reported unsafe incident occurred on the project on a date; and
an incident predictor, which includes a computer processor, configured to receive the first project data, the first observation data, and the first incident data and predict, from features that include at least one of the types of first observation data and the types of first project data that are most indicative of the occurrence of the reported unsafe incident, the likelihood of an occurrence of a first future unsafe incident at the first project.

13. The system of claim 12, further comprising:
first worker data that includes at least one of the following types:
a number of workers in each worker category on the first worksite on each date;
an age of the worker on the first worksite on each date;
an amount of experience of each worker on the first worksite on each date; and
a total number of workers on the first worksite on each date;
first weather data that includes at least one of the following types:
current weather data;
a date of the current weather data;
forecasted weather data; and
a date of the forecasted weather data,
wherein the incident predictor is configured to receive the first project data, the first observation data, the first worker data, the first weather data, and the first incident data and predict, from features that include at least one of the types of first observation data, the types of first project data, the first worker data, and the first weather data that are most indicative of the occurrence of the reported unsafe incident, the likelihood of an occurrence of a first future unsafe incident at the first project.

14. The system of claim 12, further comprising:
a data linking module configured to associate the first observation data with the first incident data by linking the date of the observation to the date of the reported unsafe incident and determine the type of first observation data and the type of first project data that are most indicative of the occurrence of the reported unsafe incident.

15. The system of claim 12, further comprising:
the incident predictor includes a machine-learning module configured to extract the features from the types of first project data and the types of first observation data that are identified by the machine-learning module as being most indicative of the occurrence of the first future unsafe incident.

16. The system of claim 15, wherein the machine-learning model is configured to determine an importance of each feature and weigh the features accordingly in predicting the likelihood of the occurrence of the first future unsafe incident.

17. The system of claim 12, further comprising:
memory in communication with the incident predictor for storing the first project data, the first observation data, and the first incident data.

18. A method of predicting the likelihood of a future unsafe incident occurring at a first worksite of a first project, the method comprising:
receiving first project data associated with the first project and first observation data associated with the first project, the first project data having a plurality of types of project data and the first observation data having a plurality of types of observation data;
extracting, by an incident predictor that includes a machine-learning model, features from the types of project data and the types of observation data that are most indicative of the occurrence of the future unsafe incident at the first worksite of the first project, wherein the extraction includes:
receiving second project data associated with a second project, the second project data includes the plurality of types of project data having different values of project data as compared to the first project data;
receiving second observation data associated with the second project, the second observation data includes the plurality of types of observation data having different values of observation data as compared to the first observation data;
receiving second incident data associated with the second project, the second incident data includes incident data regarding unsafe incidents and safe incidents at the second project;
associating the second observation data with the first incident data by linking a date of the observation data to a date of the unsafe incidents; and
identifying predictive features that include the plurality of types of project data and the plurality of types of observation data that are most indicative of an occurrence of the unsafe incident at the second project; and
predicting, by the machine-learning model and dependent upon the predictive features that are most indicative of the occurrence of a future unsafe incident, the likelihood of the future unsafe incident occurring at a first worksite of a first project.

19. The method of claim 18, wherein the step of predicting the likelihood of the future unsafe incident occurring at the first worksite further comprises:
determining an importance of each of the features to the occurrence of the future unsafe incident and weighting the features accordingly in predicting the likelihood of the occurrence of the future unsafe incident.

20. The method of claim 18, wherein the machine-learning model uses a random forest technique, an extreme gradient boosting technique, or a time series forecasting technique to identify the predictive features that are most indicative of the occurrence of the unsafe incident at the second project.
